(19) United States
(12) Patent Application Publication
(10) Pub. No.: US 2020/0349442 A1
(43) Pub. Date: Nov. 5, 2020

(54) AUTO FEED FORWARD/BACKWARD AUGMENTED REALITY LEARNING SYSTEM

(71) Applicant: MING CHUAN UNIVERSITY, Taipei (TW)

(72) Inventors: KUEI-FANG HSIAO, TAOYUAN CITY (TW); WEN-HUEI CHEN, NEW TAIPEI CITY (TW); TSAIR-YUAN CHANG, TAOYUAN CITY (TW)

(21) Appl. No.: 16/826,678

(22) Filed: Mar. 23, 2020

(30) Foreign Application Priority Data
May 3, 2019 (TW) 108115395

(51) Int. Cl. G06N 3/08; G06N 5/04; G06N 20/00; G06T 19/00; G06F 3/01; G06F 3/044; G06F 3/045

(52) U.S. Cl. CPC G06N 3/084; G06N 5/046; G06N 20/00; G06F 3/045; G06F 3/011; G06F 3/017; G06F 3/044; G06T 19/006

(57) ABSTRACT

An auto feed forward/backward augmented reality learning system includes a processing device that defines an interactive object image and a controllable object image and has a training database for storing and defining a hierarchical value of the interactive object image. The interactive object image shows different motion statuses by the hierarchical value. The processing device selects the hierarchical value according to a user's image and amount of exercise and defines a feedback value according to a result of the interaction between the user and the interactive object image. The processing device maintains or corrects the hierarchical value by the feedback value, and the learning system can change the way and status of showing the interactive object image according to the user's gender, age, height, and physical fitness without requiring expensive image recognition and computation facilities. The learning system may custom-made to fit different users' learning mode or physical training intensity.

### BACKGROUND OF INVENTION

### Field of Invention

The present invention relates to an auto feed forward/backward augmented reality learning system, in particular to a learning system that combines a data value with an interactive object image in augmented reality to control and perform an interaction with the interactive object image and correct the way and status of showing the interactive object image according to a user's gender, age, height, and physical fitness.

### Description of the Related Art

Augmented Reality (AR) is a technology of obtaining the position and angle of a camera image by field calculation, and showing the information by the image, and the scope of its applicability is broad and covers the technical areas of satellites, mobile devices, surgical treatments, and industrial and recreational fields.

Compared with traditional teaching, the Augmented Reality (AR), Internet of Things (IoT) and related equipment such as a projector, smart phone and personal computer are combined and integrated into places such as classrooms to provide clear and vivid AR images and allow users to perform interactions, so as to promote the learning effect of students.

However, the interaction of AR generally requires expensive equipment such as Kinect to recognize a user's skeleton or distinguish a human image and trace the user's position and motion by a computer with high computing power, so that the user can have interactions with a moving object defined by the AR. As to the areas such as developing countries where information construction is scarce, these areas or countries have limited funding to build the AR related equipment and cannot afford the expensive AR equipment, so that local students are unable to improve their learning effect and related social problems such as uneven teaching resources or widening urban-rural gap arise.

In view of the aforementioned problems, the inventor of the present invention based on years of experience in the field of AR interactions and conducted extensive research and experiment, and finally developed an auto forward/backward feed augmented reality learning system in accord to the present invention to overcome the problems of the prior art.

### SUMMARY OF THE INVENTION

Therefore, it is a primary objective of the present invention to overcome the aforementioned problems by providing an auto feed forward/backward augmented reality learning system, comprising: an image capturing device, for capturing a user's image; at least one touch sensing device acting as a digital input channel, for detecting a user's amount of exercise and transforming to digital signal; a processing device, coupled to the image capturing device and the touch sensing device, for analyzing the user's image and amount of exercise, and defining at least one interactive object image and at least one controllable object image, and the controllable object image setting at least one interactive instruction, and the processing device driving the controllable object image to be depended by and controlled in the image; the processing device being coupled to a training database, and the training database being provided for storing and defining a plurality of hierarchical values of the interactive object image, and the interactive object image showing different motion statuses according to different hierarchical values, and the processing device selecting one of the hierarchical values according to the image and amount of exercise; the interactive object image being interacted with the controllable object image according to the interactive instruction, and defining a feedback value according to an interactive result, and the processing device maintaining or correcting the selected hierarchical value according to the feedback value; and a projection device, coupled to the processing device, and the processing device forming an image by projecting the interactive object image and the controllable object image.

In the auto feed forward/backward augmented reality learning system, the processing device defines the user's height according to the user's image to define the selected hierarchical value in order to adjust the size of the interactive object image and the controllable object image, or the position of the interactive object image and the controllable object image projected by the projection device.

In the auto feed forward/backward augmented reality learning system, the touch sensing device senses the user's number of touches of the touch sensing device, the feedback value, the hierarchical value and a motion status of the interactive object image which depends on the number of touches of the touch sensing device.

In the auto feed forward/backward augmented reality learning system, the processing device defines and triggers the interactive instruction according to the touch of the touch sensing device by the user.

The auto feed forward/backward augmented reality learning system further comprises a wearable device, for detecting at least one physical fitness value of the user, and the feedback value and the hierarchical value depend on the physical fitness value.

In the auto feed forward/backward augmented reality learning system, the physical fitness value is one selected freely from the group consisting of the user's heart rate and blood pressure.

In the auto feed forward/backward augmented reality learning system, the touch sensing device is a pad equipped with component like piezoelectric switch, capacitive touch switch, or resistive touch sensor.

In the auto feed forward/backward augmented reality learning system, the processing device further defines at least one characteristic image, and creates a gender value for the characteristic image, and the processing device selects the hierarchical value according to the image, the amount of exercise and the gender value.

In the auto feed forward/backward augmented reality learning system, the processing device drives the hierarchical value to be depended on an age value and the processing device allows the user to input the age value.

In the auto feed forward/backward augmented reality learning system, the amount of exercise is one freely selected from the group consisting of the user's weight and an applied force value, and if the amount of exercise includes the user's weight, the processing device defines the user's height according to the user's image, and calculates a BMI value by the height and weight, so as to select the hierarchical value according to the height, the weight and the BMI value.

The auto feed forward/backward augmented reality learning system further comprises a user database coupled to the processing device for storing the user's image, amount of exercise and the selected hierarchical value.

In the auto feed forward/backward augmented reality learning system, the processing device acquire user's information by comparing the image obtained by image capturing device with the images stored in the user database in the system when the user selects to be a registered user. For the first entry user, the system adds the hierarchical values into the user database. The hierarchical values for each user would be updated from time to time when different parameters, such as duration of time, amount of exercise, learning progress, and etc., generated while using the system.

In the auto feed forward/backward augmented reality learning system, sets at least one color recognition value; the processing device analyzes the image captured by the image capturing device, and if the image captured by the image capturing device has a color block corresponding to the color recognition value, the image having a range of the color block will be used to define a characteristic area, and the controllable object image is depended on and controlled in the characteristic area, and at least one of the interactive instructions is executed according to the characteristic area.

The auto feed forward/backward augmented reality learning system further comprises at least one label object, and the label object having at least one color corresponding to the color recognition value, and the image capturing device capturing an image corresponding to the label object to let the processing device define the characteristic area.

In the auto feed forward/backward augmented reality learning system, the processing device performs a brightness correction of the image according to an ambient brightness before analyzing whether or not the image has the color block of the color recognition value, when the image captured by the image capturing device is received.

In the auto feed forward/backward augmented reality learning system, the processing device defines the interactive instruction according to a superimposition of at least one of the characteristic areas and at least one of the interactive object images.

In the auto feed forward/backward augmented reality learning system, the processing device analyzes the user's image by a RGB-D image analysis or a simplified machine learning by Neural Network Convolution (NNC).

In the auto feed forward/backward augmented reality learning system, the image capturing device is a RGB-D camera, a photography device or a smart phone.

In the auto feed forward/backward augmented reality learning system, the projection device is provided for projecting an AR image.

In the auto feed forward/backward augmented reality learning system, the touch sensing device, the processing device, the image capturing device and the projection device are coupled to each other through a signal by an Internet, local area network or Bluetooth transmission.

In summation of the description above, the present invention has the following advantages and effects:

1. The present invention captures the image of the user by the image capturing device and provides the image for analysis of the user's age, posture, gender and height by the processing device, and the touch sensing device is provided for detecting the user's weight and number of touches in order to obtain the user's BMI value, and the wearable device is provided for user's physical fitness value such as the user's heart rate or blood pressure; so that the processing device can select an appropriate hierarchical value according to the user's posture, gender, height, weight, BMI value and physical fitness value, and a corresponding motion status can be executed by the interactive object image according to the selected hierarchical value, and an interactive result can be obtained according to the controllable object image controlled by the user and the interactive object image, and a feedback value can be defined according to the physical fitness value, so as to determine whether maintain or correct the hierarchical value, and generate an appropriate learning mode or physical training intensity for the user, and achieve the effects of improving the user's learning efficiency and growth, providing an educational entertainment effect and enhancing the learning willingness of the users. In addition, the present invention will not have interaction delays caused by complicated computations, and it has the advantages of simple structure, low cost, powerful functions, and fast computation.

### BRIEF DESCRIPTION OF THE DRAWING

FIG. 1 is a schematic view of a system structure of the present invention;

FIG. 2 is a flow chart of the present invention;

FIG. 3 is a schematic view showing a status related to an interactive object image which is selected by a taller user and determined whether or not the interactive object image has been registered in a user database in accordance with the present invention;

FIG. 4 is a schematic view showing a status related to an interaction between a user's controllable object image and an interactive object image as depicted in FIG. 3;

FIG. 5 is a schematic view showing a status related to an interactive object image which is selected by a taller user and determined whether or not the interactive object image has been registered in a user database in accordance with the present invention; and

FIG. 6 is a schematic view showing a status related to an interaction between a user's controllable object image and an interactive object image as depicted in FIG. 5.

### DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

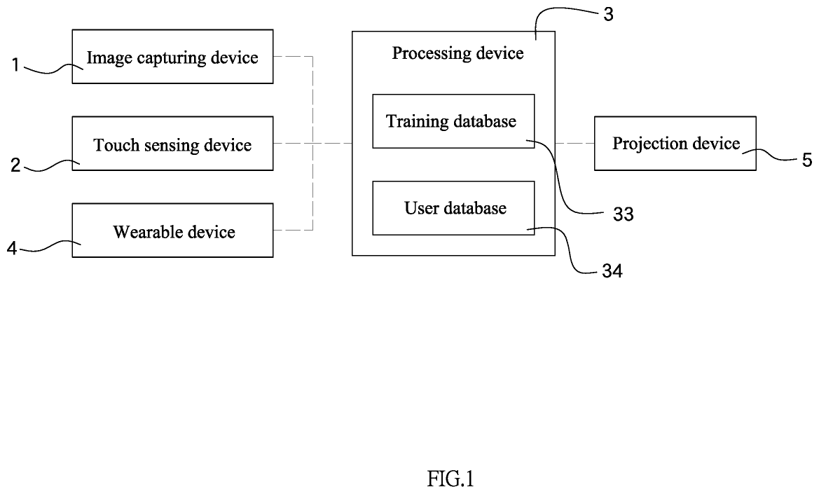

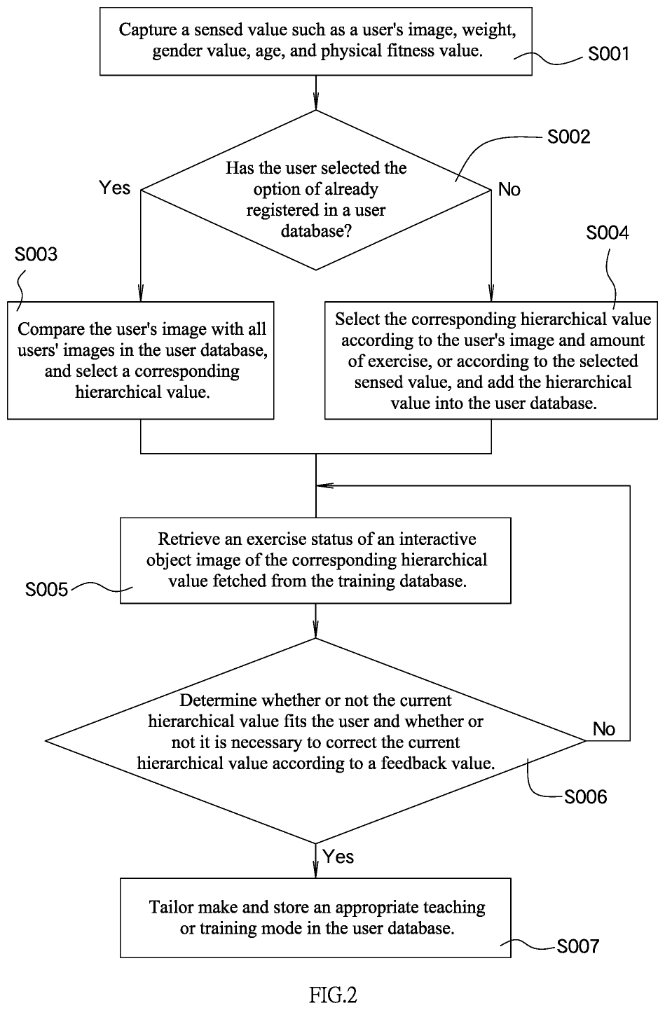

With reference to FIGS. 1 to 3 for an auto feed forward/backward augmented reality learning system of the present invention, the auto feed forward/backward augmented reality learning system comprises the following elements:

An image capturing device 1 is provided for capturing a user's image, wherein the image capturing device 1 of an embodiment includes but not limited to a RGB-D camera, a photography device or a smart phone.

At least one touch sensing device 2 is provided for detecting the user's amount of exercise, wherein the touch sensing device 2 of an embodiment may be a pad such as a floor mat placed on a floor, or a pad hanging or laying on a wall, for sensing the degree of touch of the touch sensing device 2 touched by the user, such as the number of touches and a value of the applied force, and if the touch sensing device 2 is a floor mat, then the user may step on the touch sensing device 2, so that the touch sensing device 2 can further senses the user's weight, and the image capturing device 1 can really capture the user's image to ensure the position of the user within a range interval 21 labeled by the touch sensing device 2. The touch sensing device 2 of an embodiment may comprise analog to digital component, or capacitive sensing switch, or resistive sensing switch, to transform analog signal and information to digital signals. The touch sensing device 2 may further comprise wireless communication component/device, such as WiFi or Bluetooth, or wired signal line to transmit digital signals as input data to the processing device. The shape of the sensing pad is not limited to any form, depending on the design of learning activity and exercise. The output signal of the sensing device 2 could couple to the interactive characteristic area and controllable image to diversify the designated edugaming activities. The image capturing device 1 surely can capture the image, such as camera, smartphone, video recorder, Notebook computer with image capturing functionality, webcam which can be remotely control via network, GPS cam, and drone equipped with image capturing or video recording features. A preferred embodiment is an image capturing device with wireless communication function. That allows the image capturing device 1 transmit the data to the processing device without the limit of wired configuration.

A processing device 3 is coupled to the image capturing device 1 and the touch sensing device 2 for analyzing the user's image and amount of exercise. As to the analysis of the user's image according to an embodiment, a RGB-D image analysis or a Neural Network Convolution (NNC) is used to analyze the user's image, wherein the Neural Network Convolution (NNC) analysis is not mainly used for the profound learning of the user's image, but for analyzing the weight of the image by convolution, pooling, flattening and related steps and enhancing the edge for the execution of the image analysis such as a measurement of the height, so as to reduce the time complexity of the computation, comparison and training, and in a specific embodiment, and the processing device 3 defines at least one characteristic image, and then creates a gender value for the characteristic image, and finally detects the user's gender by the aforementioned comparison and analysis of the image and the characteristic image.

For the interaction, the processing device 3 defines at least one interactive object image 31 and at least one controllable object image 32, and the controllable object image 32 sets at least one interactive instruction and the processing device 3 drives the controllable object image 32 to be depended and controlled by the user's image. For the interactive object image 31 and controllable object image 32, it is known that the controllable object image 32 is an object image corresponding to the user's movement, and the interactive object image 31 is controlled by the interactive instruction executed by the controllable object image 32 to control and change its interactive status. In a specific embodiment, the controllable object image 32 may be defined as a user's image captured by the image capturing device 1; and the interactive object image 31 is self-defined according to its application. For example, in a reaching environment, the interactive object image 31 may be set as a teaching aid image such as an animal/plant image used for the purpose of teaching, and such object image may be interacted with the user; and the interactive instruction can be defined and triggered according to the user's touch by the touch sensing device 2 and can also be triggered by a user's specific movement or posture captured by the image capturing device 1. This embodiment is used for illustrating the present invention only, but not intended for limiting the scope of the invention.

As to the definition of the interactive object image 31, the processing device 3 is coupled to a training database 33, and the training database 33 is provided for storing and defining a plurality of hierarchical values of the interactive object image 31, and the interactive object image 31 shows different motion statuses according to different hierarchical values respectively, and the motion status may be defined as a parameter of adjusting the level of difficulty for playing a game or taking a training by changing the size, position, moving speed, quantity, complexity and the like of the interactive object image 31, so that an appropriate user's hierarchical value can be evaluated, and the hierarchical value of an embodiment depends on the aforementioned sensed value such as the height, weight, gender value, and etc. Preferably, the sensed value may be selected according to requirements and depended on the hierarchical value to facilitate the selection of the hierarchical value. For example, the way of selecting the sensed value includes a selection based on the user's BMI value, the user's physical fitness value such as heart rate or blood pressure, the user's age, and the user's number of touches and force applied to the touch sensing device 2, so as to comprehensively define the level of the hierarchical value, and maintain the motion status of the interactive object image 31 to be corresponsive to the user's motion status to facilitate the interaction. This embodiment is used for illustrating the present invention only, but not intended for limiting the scope of the invention. As described above, the BMI value can be obtained according to the aforementioned height and weight in the BMI formula of this embodiment, and the user's physical fitness value can be detected by a wearable device 4 worn by the user; and the user's age can be inputted by the user. Therefore, the processing device 3 can evaluate and select the user's appropriate hierarchical value at the beginning ahead of time according to the aforementioned method.

Since the physical fitness, function, and response of each user vary, therefore the processing device 3 defines a feedback value according to the interactive result after the interactive object image 31 is interacted with the controllable object image 32 according to the interactive instruction to fit each user, so that the processing device 3 can maintain or correct the selected hierarchical value according to the feedback value; and

A projection device 5 is coupled to the processing device 3, and the processing device 3 projects and forms the interactive object image 31 and the controllable object image 32. In an embodiment, the projection device 5 projects an AR image.

As to the connection method in a specific embodiment, the touch sensing device 2, the processing device 3, the image capturing device 1 and the projection device 5 are connected by the Internet, local area network or Bluetooth via signals. This embodiment is provided for illustrating the present invention only, but not intended for limiting the scope of the invention.

With reference to FIGS. 1 to 3 for the implementation steps of the present invention:

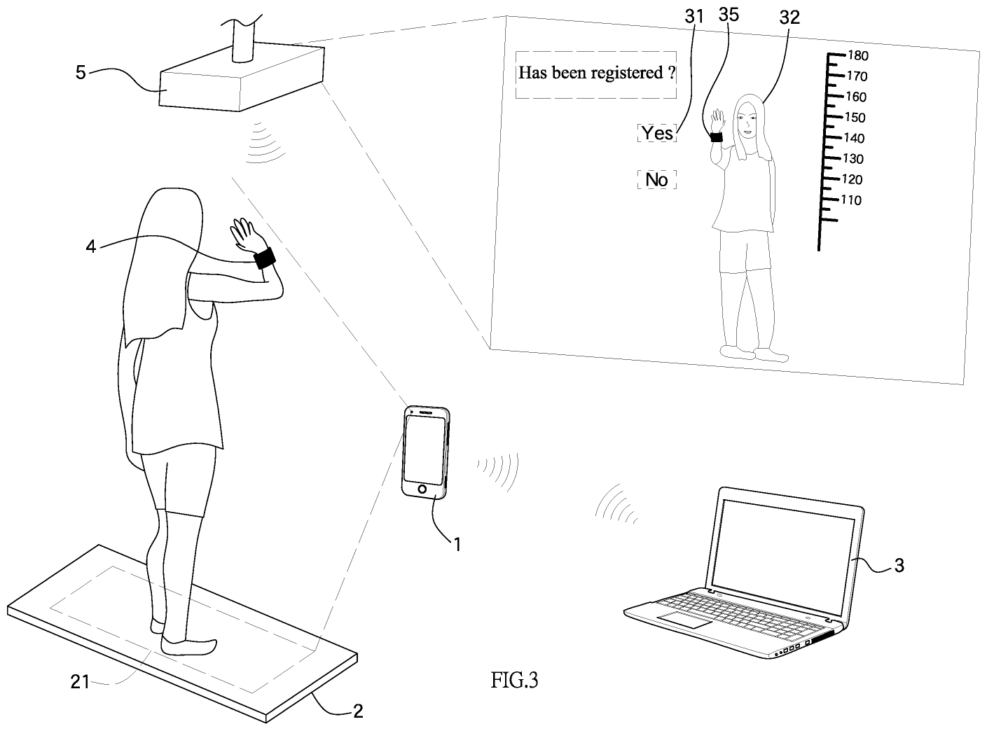

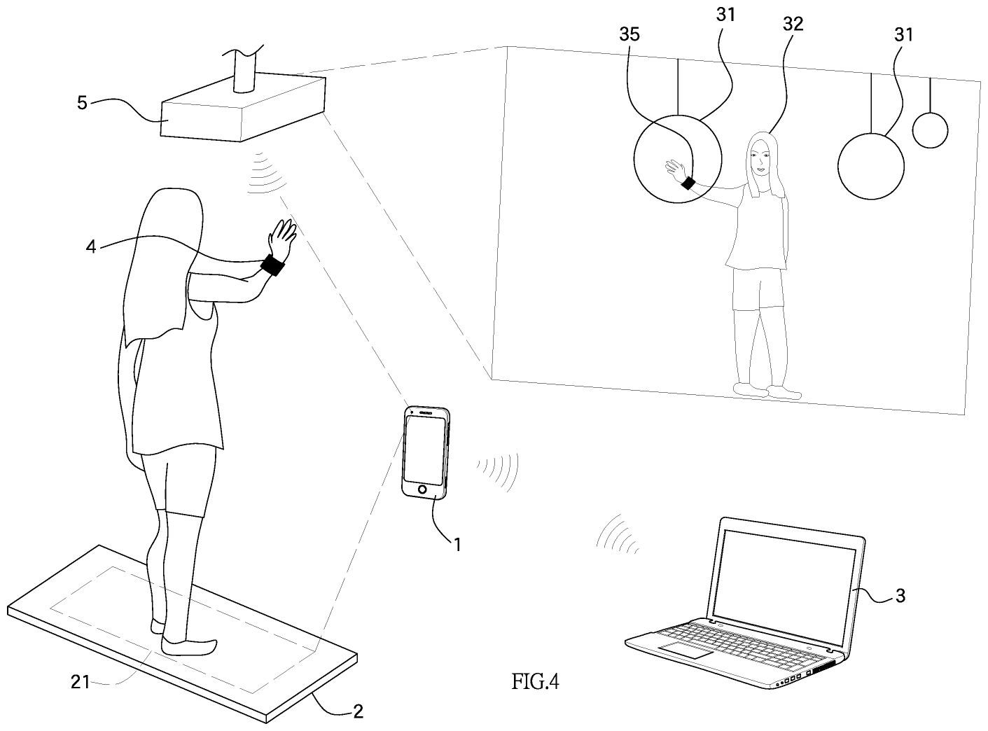

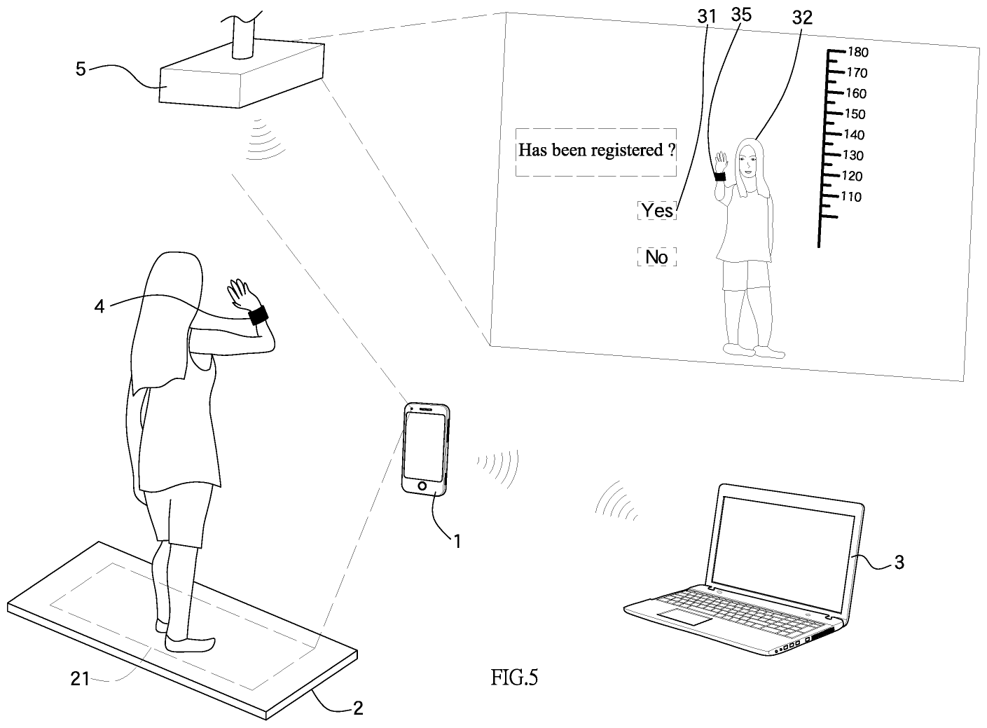

S001: The image capturing device 1 captures the user's image, while the touch sensing device 2 is sensing the user's weight and the wearable device 4 detects the user's physical fitness value. During the detection of the image, the user's gender can be detected according to the characteristic image, and an initialization can be made according to user's height or the hierarchical value preliminarily selected according to the sensed value in order to initially show the size of the interactive object image 31 and the controllable object image 32 or the positon projected by the projection device 5. In FIGS. 3 and 4, if the user's height is relatively tall, then the interactive object image 31 and the controllable object image 32 will be corresponsive to the user's height and disposed at a higher position. In FIGS. 4 and 5, if the user's height is relatively short, then the position and size of the interactive object image 31 and the controllable object image 32 will be lower and smaller respectively.

S002: A user database 34 is preferably created to facilitate recording of the user's use of information and expedite showing and selecting the user's corresponding hierarchical value for the interaction, wherein the user database 34 is coupled to the processing device 3 for storing the user's image, amount of exercise and the selected hierarchical value and prompting whether or not the user has been registered in the user database 34.

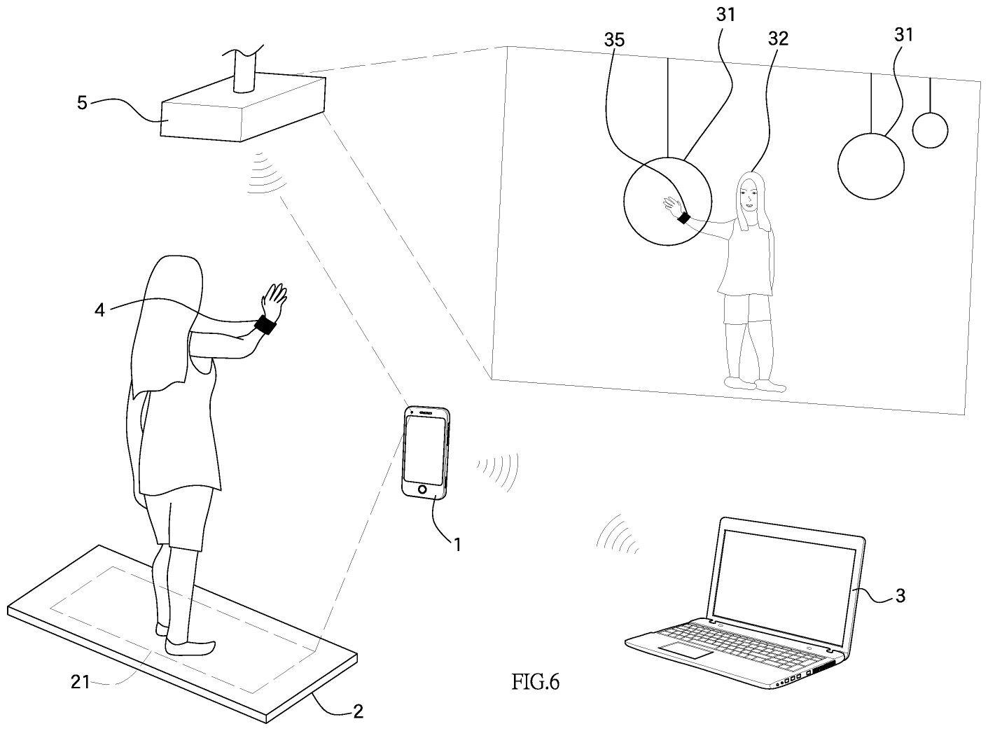

In FIGS. 3 and 5, when the image capturing device 1 detects a user at the first time, the processing device 3 allows the user to select an option whether or not the user has been registered in the user database. In an embodiment, the interactive object image 31 is displayed as an option box which is provided for the user to answer and select, so that the user can control the controllable object image 32 and select whether or not the user has been registered in the user database 34 by an interaction method. The method of controlling the controllable object image 32 for the interaction is a prior art, and there are many ways of achieving the same effect, but this embodiment of the invention can the amount of calculation, wherein the interactive object image 31 and the controllable object image 32 of the invention will not have delays. When the processing device 3 sets at least one color recognition value and analyzes the image captured by the image capturing device 1, and the image captured by the image capturing device 1 has a color block corresponding to the color recognition value, the range of the image having the color block is defined as a characteristic area 35, and the controllable object image 32 is depended on and controlled by the characteristic area 35. At least one of the interactive instructions is executed according to the characteristic area 35 to facilitate determining and triggering the interactive instruction. In an embodiment as shown in FIGS. 4 and 6, the processing device 3 defines the interactive instruction according to the superimposition of at least one of the characteristic areas 35 and at least one of the interactive object images 31. Specifically, the user wears at least one label object, wherein the label object sets at least one color corresponding to the color recognition value, and the image capturing device 1 captures an image of the label object, so that the processing device 3 defines the characteristic area 35. Preferably, the label object may be the wearable device 4. In other words, the appearance of the wearable device 4 includes at least one color corresponding to the color recognition value for defining the characteristic area 35. In an embodiment, the processing device 3 corrects the brightness of the image according to the ambient brightness, and analyzes whether or not the image has a color block of the color recognition value, when the image captured by the image capturing device 1 is received, so as to prevent the ambient light from affecting the recognition of the color. This embodiment is provided for illustrating the present invention only, but not intended for limiting the scope of the invention.

S003: The user's image will be compared with all of the users' images stored in the user database 34 to select the corresponding hierarchical value, if the user selects the option that the user has been registered.

S004: The hierarchical value will be selected according to the image and the amount of exercise or the sensed value and then added into the user database 34, if the user has not been registered.

S005: After the hierarchical value is selected according to the user's sensed value, or the hierarchical value is selected according to the user database 34, the motion status of the interactive object image 31 corresponding to the hierarchical value retrieved from the training database 33 is provided for the projection device 5 to project and form an image, so as to show an interactive object image 31 according to a pre-defined teaching mode or sports teaching mode as shown in FIGS. 4 and 6, wherein the interactive object image 31 in the shape of a balloon is provided for the user to control the controllable object image 32 by the aforementioned interaction method for the interaction in order to achieve the effect of the game and training.

S006: Since the physical fitness, function, and response of each user vary, therefore the processing device 3 defines a feedback value according to an interactive result of the user and the interactive object image 31, and the processing device 3 maintains or corrects the selection of the hierarchical value according to the feedback value. In an embodiment, the feedback value may be set as a threshold. If the interactive result of the user and the interactive object image 31 is changed (for example, if the interactive object image 31 includes a plurality of floating balloons, and the controllable object image 32 and the interactive object image 31 are superimposed), and the interaction status of the interactive object image 31 indicates a burst, then the feedback value will be information such as the frequency or quantity of the balloons burst by the user, so that the processing device 3 can determine whether to maintain or correct the hierarchical value. In another embodiment, if the interactive object image 31 requires the user to carry out the interactive instruction for one or more touches, such as jumping or stepping on an image shown on a floor or stretching hands or body for a touch, then the touch sensing device 2 will sense the user's number of touches of the touch sensing device 2. Now, the motion status of the feedback value, the hierarchical value and the interactive object image 31 depends on the number of touches of the touch sensing device. In addition, the user's physical fitness usually deteriorates after a long time of exercise, so that the feedback value and the hierarchical value may depend on the physical fitness value, and the hierarchical value may be corrected according to the user's degree of fatigue or physical fitness and an appropriate teaching or training mode can be tailor-made. If the user cannot complete or achieve the current predetermined threshold of the interaction with the interactive object image 31, then the processing unit will automatically lower the hierarchical value. If the user can complete or achieve the current predetermined threshold of the interaction with the interactive object image 31, then the hierarchical value will be adjusted to a higher value. By repeating this process, the user can determine whether or not the current hierarchical value fits the user.

S007: If the selected hierarchical value fits the user, then an appropriate teaching or training mode can be tailored-made and stored in the user database 34 and provided for the user to selectively continue or not discontinue the current training. Obviously, the present invention can produce an appropriate learning mode or physical training intensity for users and improve the learning efficiency and growth of the users.

While the present invention has been described by means of specific embodiments, numerous modifications and variations could be made thereto by those skilled in the art without departing from the scope and spirit of the present invention set forth in the claims.

What is claimed is:

1. An auto feed forward/backward augmented reality learning system, comprising:
an image capturing device, for capturing a user's image;
at least one touch sensing device, wherein the touch sensing device further comprising at least one resistive or capacitive sensing switch for detecting a user's amount of exercise;
a training database, for storing the user's registration data and a plurality of hierarchical values;
a processing device, coupled to the image capturing device and the touch sensing device, for analyzing the user's image and amount of exercise, and defining at least one interactive object image and at least one controllable object image, and the controllable object image setting at least one interactive instruction, and the processing device driving the controllable object image to be depended by and controlled in the image; the processing device being coupled to the training database, and the training database being provided for storing and defining a plurality of hierarchical values of the interactive object image, and the interactive object image showing different motion statuses according to different hierarchical values, and the processing device selecting one of the hierarchical values according to the image and amount of exercise;
the interactive object image being interacted with the controllable object image according to the interactive instruction, and defining a feedback value according to an interactive result, and the processing device maintaining or correcting the selected hierarchical value according to the feedback value; and
a projection device, coupled to the processing device, and the processing device forming an image by projecting the interactive object image and the controllable object image.

2. The auto feed forward/backward augmented reality learning system as claimed in claim 1, wherein the processing device defines the user's height according to the user's image to define the selected hierarchical value in order to adjust the size of the interactive object image and the controllable object image, or the position of the interactive object image and the controllable object image projected by the projection device.

3. The auto feed forward/backward augmented reality learning system as claimed in claim 1, wherein the touch sensing device senses the user's number of touches of the touch sensing device, the feedback value, the hierarchical value and a motion status of the interactive object image which depends on the number of touches of the touch sensing device.

4. The auto feed forward/backward augmented reality learning system as claimed in claim 1, wherein the processing device defines and triggers the interactive instruction according to the touch of the touch sensing device by the user.

5. The auto feed forward/backward augmented reality learning system as claimed in claim 1, further comprising a wearable device, for detecting at least one physical fitness value of the user, and the feedback value and the hierarchical value depend on the physical fitness value.

6. The auto feed forward/backward augmented reality learning system as claimed in claim 5, wherein the physical fitness value is one selected freely from the group consisting of the user's heart rate and blood pressure.

7. The auto feed forward/backward augmented reality learning system as claimed in claim 1, wherein the touch sensing device is a mat with at least one analog to digital component and with wireless communication feature to couple the processing device.

8. The auto feed forward/backward augmented reality learning system as claimed in claim 1, wherein the processing device further defines at least one characteristic image, and creates a gender value for the characteristic image, and the processing device selects the hierarchical value according to the image, the amount of exercise and the gender value.

9. The auto feed forward/backward augmented reality learning system as claimed in claim 1, wherein the processing device drives the hierarchical value to be depended on an age value, and the processing device allows the user to input the age value.

10. The auto feed forward/backward augmented reality learning system as claimed in claim 1, wherein the amount of exercise is one freely selected from the group consisting of the user's weight and an applied force value, and if the amount of exercise includes the user's weight, the processing device defines the user's height according to the user's image, and calculates a BMI value by the height and weight, so as to select the hierarchical value according to the height, the weight and the BMI value.

11. The auto feed forward/backward augmented reality learning system as claimed in claim 1, further comprising a user database coupled to the processing device for storing the user's image, amount of exercise and the selected hierarchical value.

12. The auto feed forward/backward augmented reality learning system as claimed in claim 11, wherein the processing device lets the user select whether or not to be registered into the user database when the image capturing device detects the user for the first time, and compares the user's image with all users' images stored in the user database if the user has selected to be registered into the user database in order to select the corresponding hierarchical value; and selects the hierarchical value according to the image and the amount of exercise, and adds the hierarchical value into the user database if the user has not been registered into the user database.

13. The auto feed forward/backward augmented reality learning system as claimed in claim 1, wherein the processing device sets at least one color recognition value; the processing device analyzes the image captured by the image capturing device, and if the image captured by the image capturing device has a color block corresponding to the color recognition value, the image having a range of the color block will be used to define a characteristic area, and the controllable object image is depended on and controlled in the characteristic area, and at least one of the interactive instructions is executed according to the characteristic area.

14. The auto feed forward/backward augmented reality learning system as claimed in claim 13, further comprising at least one label object, and the label object having at least one color corresponding to the color recognition value, and the image capturing device capturing an image corresponding to the label object to let the processing device define the characteristic area.

15. The auto feed forward/backward augmented reality learning system as claimed in claim 13, wherein the processing device performs a brightness correction of the image according to an ambient brightness before analyzing whether or not the image has the color block of the color recognition value, when the image captured by the image capturing device is received.

16. The auto feed forward/backward augmented reality learning system as claimed in claim 13, wherein the processing device defines the interactive instruction according to a superimposition of at least one of the characteristic areas and at least one of the interactive object images.

17. The auto feed forward/backward augmented reality learning system as claimed in claim 1, wherein the processing device analyzes the user's image by a RGB-D image analysis or a Neural Network Convolution (NNC).

18. The auto feed forward/backward augmented reality learning system as claimed in claim 1, wherein the image capturing device is a RGB-D camera, a photography device or a smart phone.

19. The auto feed forward/backward augmented reality learning system as claimed in claim 1, wherein the projection device is provided for projecting an AR image.

20. The auto feed forward/backward augmented reality learning system as claimed in claim 1, wherein the touch sensing device, the processing device, the image capturing device and the projection device are coupled to each other through a signal by an Internet, local area network or Bluetooth transmission.
